(19) United States
(12) Patent Application Publication
(10) Pub. No.: US 2017/0288275 A1
(43) Pub. Date: Oct. 5, 2017

(54) ELECTROCHEMICAL DEVICE

(71) Applicant: TAIYO YUDEN CO., LTD., Tokyo (JP)

(72) Inventors: Katsunori YOKOSHIMA, Takasaki-shi (JP); Shinji ISHII, Takasaki-shi (JP); Koji KANO, Takasaki-shi (JP); Hiroki TAKAHASHI, Takasaki-shi (JP); Takatoshi NAGASE, Takasaki-shi (JP)

(21) Appl. No.: 15/474,349

(22) Filed: Mar. 30, 2017

(30) Foreign Application Priority Data
Mar. 30, 2016 (JP) 2016-069137

(51) Int. Cl. H01M 10/0587; H01G 11/52; H01M 10/42; H01G 11/28; H01M 10/0525; H01M 4/587

(52) U.S. Cl. CPC H01M 10/0587; H01M 10/0525; H01M 4/587; H01M 10/4235; H01G 11/28; H01G 11/52

(57) ABSTRACT

An electrochemical device has a positive electrode, a negative electrode, a negative-electrode terminal, separators, and electrolytic solution, where the positive electrode, negative electrode, and separators are stacked and wound together. The negative-electrode terminal is made of metal, and has a joining part which is a part joined to the principal face of the negative-electrode collector. A protective tape is made of insulating material and attached to the negative electrode to cover the joining part. The negative electrode has a first width along the direction parallel with the axis of winding. The positive electrode has a second width, which is smaller than the first width, along the direction parallel with the axis of winding. The length of the protective tape along the direction parallel with the axis of winding is equal to or greater than the second width.

### BACKGROUND

### Field of the Invention

The present invention relates to an electrochemical device having an electric storage element constituted by a positive electrode, a negative electrode, and separators, being wound together.

### Description of the Related Art

Lithium ion capacitors, electric double-layer capacitors, lithium ion secondary batteries, and other electrochemical devices are constituted in such a way that an electric storage element, constituted by a positive electrode and a negative electrode stacked together with a separator in between, is immersed in electrolytic solution. Wound-type electrochemical devices formed by winding together a positive electrode, a negative electrode, and separators, are also widely used.

Joined to the positive electrode and negative electrode, respectively, are electrode terminals used for electrical connection with the outside. For example, Patent Literature 1 describes an electric double-layer capacitor with a structure where electrodes, each having an electrode terminal joined to it, are wound together. The electrodes are formed by foil-shaped current collectors on which an electrode material is applied, but they also have current-collector exposed areas where the electrode material is not applied, and the electrode terminals are connected to the current collectors in these current-collector exposed areas.

### BACKGROUND ART LITERATURES

[Patent Literature 1] Japanese Patent Laid-open No. 2014-229860
[Patent Literature 2] Japanese Patent Laid-open No. 2007-109702

### SUMMARY

According to the aforementioned configuration, a protective tape for covering the current-collector exposed areas is attached on the electrodes to protect the current-collector exposed areas. The protective tape is made of polypropylene, polyethylene, polyimide, or other insulating material. However, attaching the protective tape on the current-collector exposed area of the negative electrode may cause a non-uniform structure to form because the electrode has areas with and without the protective tape in its width direction, which in turn may promote local deterioration of the electric storage element.

In light of the aforementioned situation, an object of the present invention is to provide an electrochemical device that can suppress local deterioration of electric storage elements caused by protective tapes.

Any discussion of problems and solutions involved in the related art has been included in this disclosure solely for the purposes of providing a context for the present invention, and should not be taken as an admission that any or all of the discussion were known at the time the invention was made.

To achieve the aforementioned object, the electrochemical device pertaining to an embodiment of the present invention has a positive electrode, a negative electrode, a negative-electrode terminal, separators, and electrolytic solution, where the positive electrode, negative electrode, and separators are stacked and wound together in such a way that the separators separate the positive electrode and negative electrode. The negative electrode has a negative-electrode collector being a metal foil, and a negative-electrode active material layer formed on the principal face of the negative-electrode collector. The positive electrode has a positive-electrode collector being a metal foil, and a positive-electrode active material layer formed on the principal face of the positive-electrode collector. The negative-electrode terminal is made of metal, and has a joining part which is a part joined to the principal face of the negative-electrode collector. The protective tape is made of insulating material and attached to the negative electrode to cover the joining part. The separators insulate the positive electrode and negative electrode. The electrolytic solution immerses the positive electrode, negative electrode, and separators. The negative electrode has a first width along the direction parallel with the axis of winding. The positive electrode has a second width, which is smaller than the first width, along the direction parallel with the axis of winding. The length of the protective tape along the direction parallel with the axis of winding is equal to or greater than the second width.

In the configuration where the positive electrode and negative electrode are stacked and wound together with the separator in between, the positive-electrode active material and negative-electrode active material are facing each other via the separator over large parts of the positive electrode and negative electrode; in some parts, however, the protective tape covering the negative-electrode terminal is facing the positive-electrode active material via the separator. If the length of the protective tape is smaller than the width of the positive electrode (second width), an area where the protective tape is present and an area where the protective tape is absent are formed on the negative electrode in the direction parallel with the axis of winding. The area where the protective tape is absent represents a non-uniform area that faces the positive electrode via the separator and reacts with the part of the positive electrode it faces, and also with parts of the positive electrode in the vicinity thereof, to cause charging and discharging to occur. This non-uniformity promotes local deterioration of the electric storage element. According to the aforementioned configuration, the fact that the length of the protective tape is equal to or greater than the width of the positive electrode prevents the formation of an area where the protective tape is present, and an area where the protective tape is absent, in the direction parallel with the axis of winding. As a result, local deterioration of the electric storage element can be suppressed.

Lithium ions may be pre-doped into the negative-electrode active material layer.

The electrochemical device pertaining to the present invention may be a lithium ion capacitor whose negative-electrode active material layer is pre-doped with lithium ions. Lithium ion capacitors generally have a structure where the width of the negative electrode is greater than the width of the positive electrode; however, the structural non-uniformity arising from the positive electrode and negative electrode having different widths can be improved by the aforementioned configuration.

The negative electrode may have a negative-electrode non-forming region where the negative-electrode active material layer is not formed on the principal face, the negative-electrode terminal may be joined to the negative-electrode collector in the negative-electrode non-forming region, and the protective tape may be attached to the negative-electrode active material layer around the negative-electrode non-forming region and cover the negative-electrode non-forming region and the joining part.

As described above, an electrochemical device that can suppress local deterioration of electric storage elements caused by protective tapes can be provided according to the present invention.

For purposes of summarizing aspects of the invention and the advantages achieved over the related art, certain objects and advantages of the invention are described in this disclosure. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

Further aspects, features and advantages of this invention will become apparent from the detailed description which follows.

### BRIEF DESCRIPTION OF THE DRAWINGS

These and other features of this invention will now be described with reference to the drawings of preferred embodiments which are intended to illustrate and not to limit the invention. The drawings are greatly simplified for illustrative purposes and are not necessarily to scale.

FIG. 1 is a perspective view of an electrochemical device pertaining to an embodiment of the present invention.

FIG. 2 is a perspective view of the electric storage element of the electrochemical device.

FIG. 3 is a cross sectional view of the electric storage element.

FIGS. 4A and 4B are plan views of the negative electrode of the electric storage element.

FIG. 5 is a plan view of the negative-electrode terminal not yet joined to the negative electrode of the electric storage element.

FIG. 6 is a plan view of the negative-electrode terminal joined to the negative electrode of the electric storage element.

FIG. 7 is a cross sectional view of the negative-electrode terminal joined to the negative electrode of the electric storage element.

FIGS. 8A and 8B are plan views of the negative electrode of the electric storage element.

FIG. 9 is a plan view of the negative electrode of the electric storage element.

FIG. 10 is a cross sectional view of the negative electrode of the electric storage element.

FIGS. 11A and 11B are plan views of the positive electrode of the electric storage element.

FIGS. 12A and 12B are plan views of the positive electrode of the electric storage element.

FIG. 13 is a plan view showing the positive electrode, negative electrode, and separators of the electric storage element before winding.

FIG. 14 is a plan view showing the positive electrode and negative electrode of the electric storage element before winding.

FIG. 15 is a cross sectional view of the electric storage element.

FIG. 16 is a plan view showing the negative-electrode terminal of the electric storage element of the electrochemical device pertaining to a comparative example of the present invention.

FIG. 17 is a cross sectional view of the electric storage element of the comparative example.

FIG. 18 is a plan view showing the negative-electrode terminal of the electric storage element of the electrochemical device pertaining to a variation example of the present invention.

FIG. 19 is a cross sectional view of the electric storage element.

FIG. 20 is a table showing the measured results of the electrochemical devices pertaining to examples and comparative examples of the present invention.

FIG. 21 is a graph showing the measured results of the electrochemical devices pertaining to an example and a comparative example of the present invention.

### DESCRIPTION OF THE SYMBOLS

100—Electrochemical device

110—Electric storage element

130—Negative electrode

130a—Negative-electrode non-forming region

131—Negative-electrode terminal

131b—Joining part

136—Protective tape

140—Positive electrode

140a—Positive-electrode non-forming region

141—Positive-electrode terminal

144—Protective tape

150—Separator

### DETAILED DESCRIPTION OF EMBODIMENTS

The electrochemical device 100 pertaining to this embodiment is explained. The electrochemical device 100 may be a lithium ion capacitor. The electrochemical device 100 may also be an electric double-layer capacitor, lithium ion secondary battery, or other type of electrochemical device that can be charged and discharged.

[Configuration of Electrochemical Device]

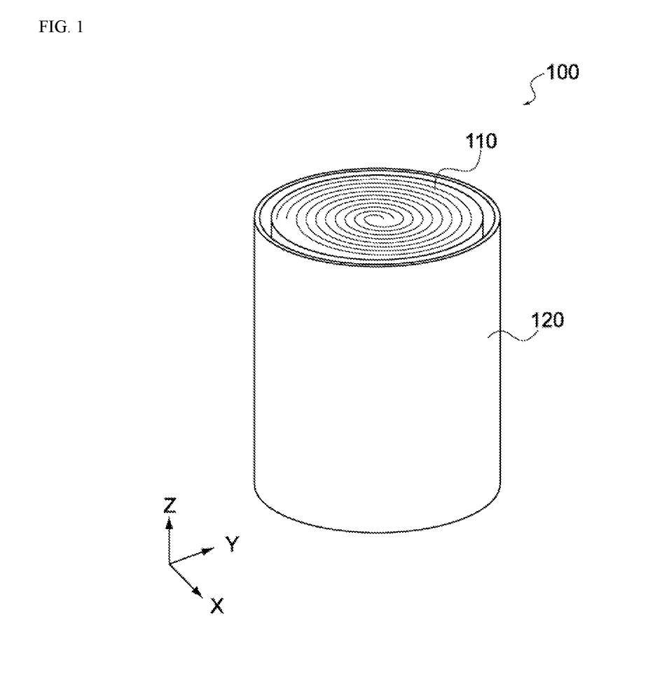

FIG. 1 is a perspective view showing the configuration of the electrochemical device 100 pertaining to this embodiment. As shown in the figure, the electrochemical device 100 is constituted by an electric storage element 110 and a container 120 (its lid and terminals are not illustrated) housing it. Electrolytic solution is housed in the container 120, together with the electric storage element 110.

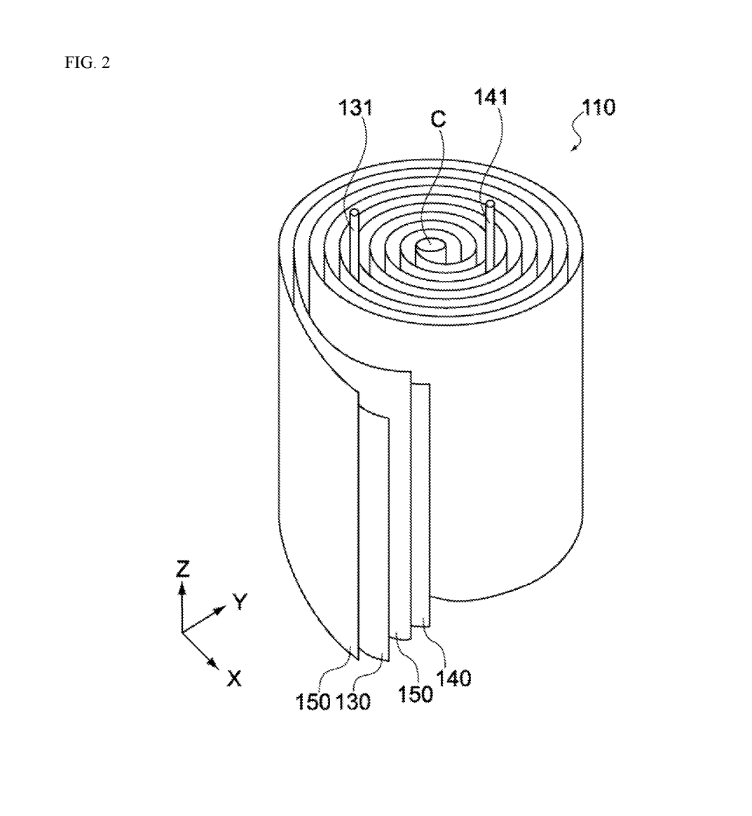

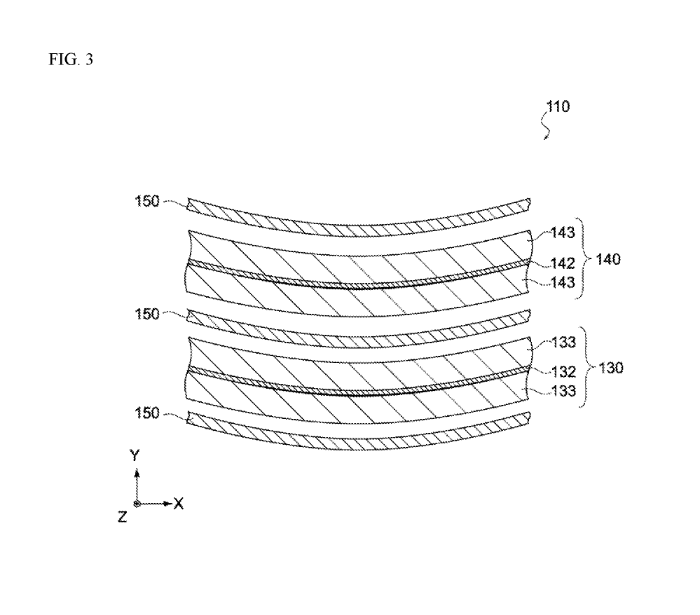

FIG. 2 is a perspective view of the electric storage element 110, while FIG. 3 is an enlarged cross sectional view of the electric storage element 110. As shown in FIGS. 2 and 3, the electric storage element 110 has a negative electrode 130, a positive electrode 140, and separators 150, and is constituted in such a way that a laminate, consisting of the foregoing stacked together, is wound around a winding core C. The direction in which the winding core C extends, or specifically the direction parallel with the center axis of winding, is hereinafter referred to as the “Z direction.” The X direction represents the direction perpendicular to the Z direction, while the Y direction represents the direction perpendicular to the X direction and Z direction. It should be noted, also, that the winding core C need not be provided.

The negative electrode 130, positive electrode 140, and separators 150 constituting the electric storage element 110 are stacked in the order of separator 150, negative electrode 130, separator 150, and positive electrode 140, toward the winding core C (from the outer side of winding), as shown in FIG. 2. Also, the electric storage element 110 has a negative-electrode terminal 131 and a positive-electrode terminal 141, as shown in FIG. 2. The negative-electrode terminal 131 is connected to the negative electrode 130, while the positive-electrode terminal 141 is connected to the positive electrode 140, and both are led out to the exterior of the electric storage element 110, as shown in FIG. 2.

The negative electrode 130 has a negative-electrode collector 132 and negative-electrode active material layers 133, as shown in FIG. 3. The negative-electrode collector 132 is made of conductive material, and may be a copper foil or other metal foil. The negative-electrode collector 132 may be a metal foil whose surface is roughened by a chemical or mechanical means, or a metal foil in which through holes have been formed. The thickness of the negative-electrode collector 132 may be 15 μm, for example.

The negative-electrode active material layers 133 are formed on the negative-electrode collector 132. The material for the negative-electrode active material layers 133 may be a mixture of a negative-electrode active material and a binder resin, which may further contain a conductive aid. For the negative-electrode active material, any material capable of adsorbing lithium ions in the electrolytic solution may be used, such as non-graphitizable carbon (hard carbon), graphite, soft carbon, or other carbon material.

For the binder resin, any synthetic resin that joins the negative-electrode active material may be used, such as carboxy methyl cellulose, styrene butadiene rubber, polyethylene, polypropylene, polyethylene terephthalate, aromatic polyamide, fluororubber, polyvinylidene fluoride, isoprene rubber, butadiene rubber, and ethylene propylene rubber, for example.

The conductive aid is constituted by grains made of conductive material, and improves the conductivity between negative-electrode active materials. The conductive aid may be acetylene black, graphite, carbon black, or other carbon material, for example. Any of these may be used alone or multiple types may be mixed. It should be noted that the conductive aid may be a material having conductivity, such as metal material and conductive polymer, among others.

The negative-electrode active material layer 133 may be provided directly on the negative-electrode collector 132, or it may be provided on an undercoat layer provided on the negative-electrode collector 132. The thickness of the negative-electrode active material layer 133 may be 50 μm, for example.

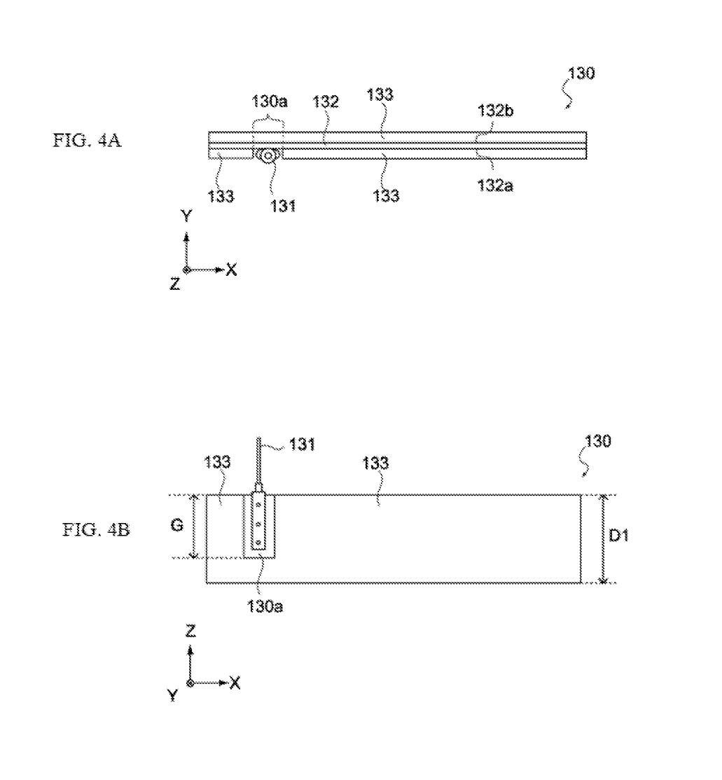

FIGS. 4A and 4B provide schematic views showing the negative electrode 130 before winding, where FIG. 4A is a view from the Z direction, while FIG. 4B is a view from the Y direction. As shown in FIG. 4A, the negative-electrode active material layer 133 is formed on both the first principal face 132a and second principal face 132b of the negative-electrode collector 132 of the negative electrode 130. It should be noted that the negative-electrode active material layer 133 may be formed only on the first principal face 132a.

As shown in these figures, the negative electrode 130 has a rectangular shape. The width of the short side of the negative electrode 130 is defined as the first width D1. The first width D1 represents the width along the direction (Z direction) parallel with the center axis of winding when the negative electrode 130 is wound with the positive electrode 140 and separators 150.

As shown in FIGS. 4A and 4B, the negative electrode 130 has a negative-electrode non-forming region 130a and the negative-electrode terminal 131 is joined to the negative-electrode non-forming region 130a. The negative-electrode non-forming region 130a is a region where the negative-electrode active material layer 133 is not provided on the first principal face 132a and the negative-electrode collector 132 is exposed. When the width along the direction (Z direction) parallel with the center axis of winding of the negative-electrode non-forming region 130a is defined as width G, then width G is smaller than the first width D1.

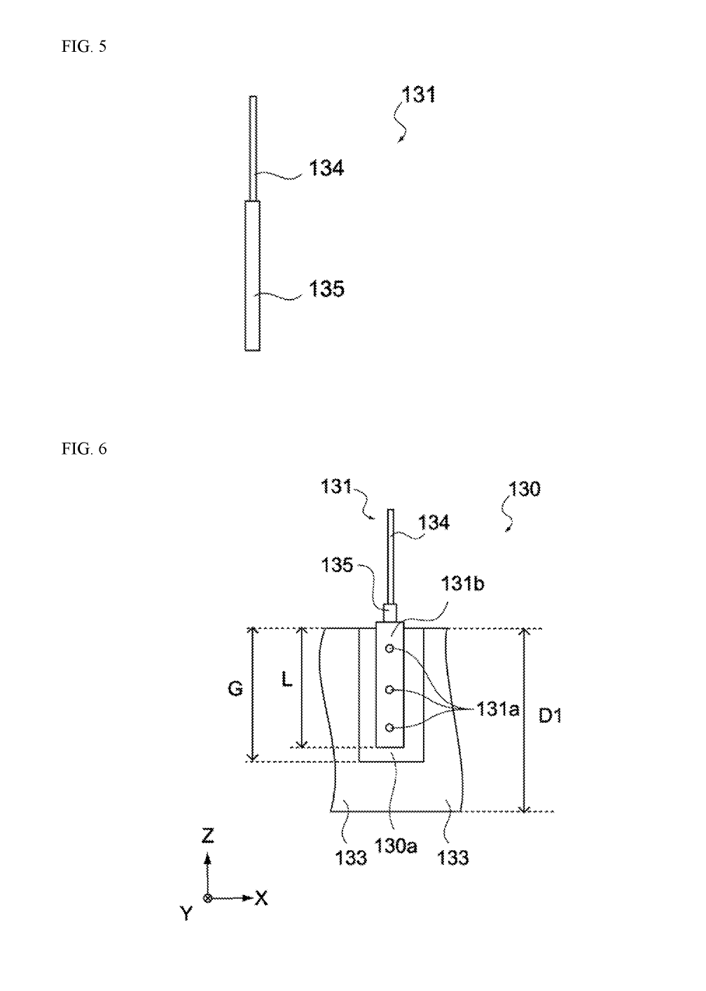

The negative-electrode terminal 131 is joined to the negative-electrode collector 132 exposed in the negative-electrode non-forming region 130a, and is electrically connected to the negative-electrode collector 132. FIG. 5 is a plan view showing the negative-electrode terminal 131 not yet joined. As shown in this figure, the negative-electrode terminal 131 has a linear member 134 and a linear member 135. The linear member 134 is a line-shaped metal member made of copper, etc., while the linear member 135 is also a line-shaped metal member made of copper, etc. The negative-electrode terminal 131 is constituted by the linear members 134, 135 joined together by means of resistance welding, etc.

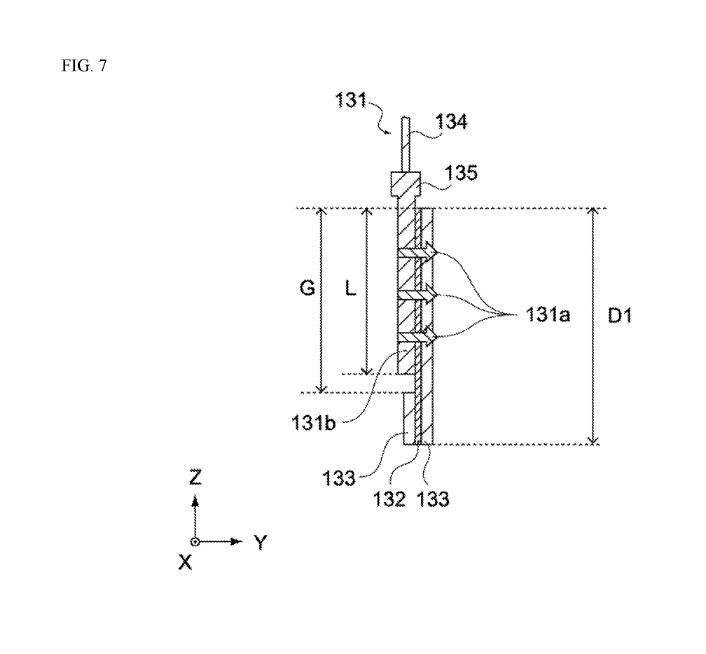

The negative-electrode terminal 131 may be joined to the negative-electrode collector 132 by means of needle crimping. FIG. 6 is a plan view of the negative-electrode terminal 131 joined to the negative-electrode collector 132, while FIG. 7 is a cross sectional view of the negative-electrode terminal 131 joined to the negative-electrode collector 132.

As shown in these figures, the negative-electrode terminal 131 can be joined to the negative-electrode collector 132 by pressing the linear member 135 against the negative-electrode collector 132, while crimping it using a needle 131a at the same time (“needle crimping” refers to joining the layers by deforming the linear member using a needle). This way, the linear member 135 is crushed, except for some areas, and becomes flat. The needle 131a, as shown in FIG. 7, pierces through the linear member 135, negative-electrode collector 132, and negative-electrode active material layer 133, and fixes them together. It should be noted that the method for joining the negative-electrode terminal 131 to the negative-electrode collector 132 is not limited to needle crimping; instead, bonding using conductive adhesive, welding, etc., may be used. In some embodiments, the needle crimping is fixing the linear member 135 to the negative-electrode collector 132 and negative-electrode active material layer 133 by (i) piercing the needle 131a through the linear member 135, negative-electrode collector 132, and negative-electrode active material layer 133, (ii) causing a part of the linear member 135 contacting the needle 131a to be stretched (since it is made of metal) and to penetrate through the negative-electrode collector 132 and the negative-electrode active material layer 133 around the needle 131a by friction force generated by the penetrating needle 131a, thereby causing the tip of the stretched part of the linear member 135 around the needle 131a to project from the negative-electrode active material layer 133, (iii) retracting the needle 131a and pulling it out from the linear member 135, and (iv) flattening the projected tip of the stretched part of the linear member 135 so as to fix the linear member 135 to the negative-electrode collector 132 and negative-electrode active material layer 133 (the flattened part functions as a rivet). In this disclosure, “needle crimping” or “using a needle” includes the above embodiment.

As shown in FIGS. 6 and 7, the part of the negative-electrode terminal 131 being joined to the negative-electrode collector 132 is defined as a joining part 131b. Also, the length of the joining part 131b along the Z direction is defined as length L.

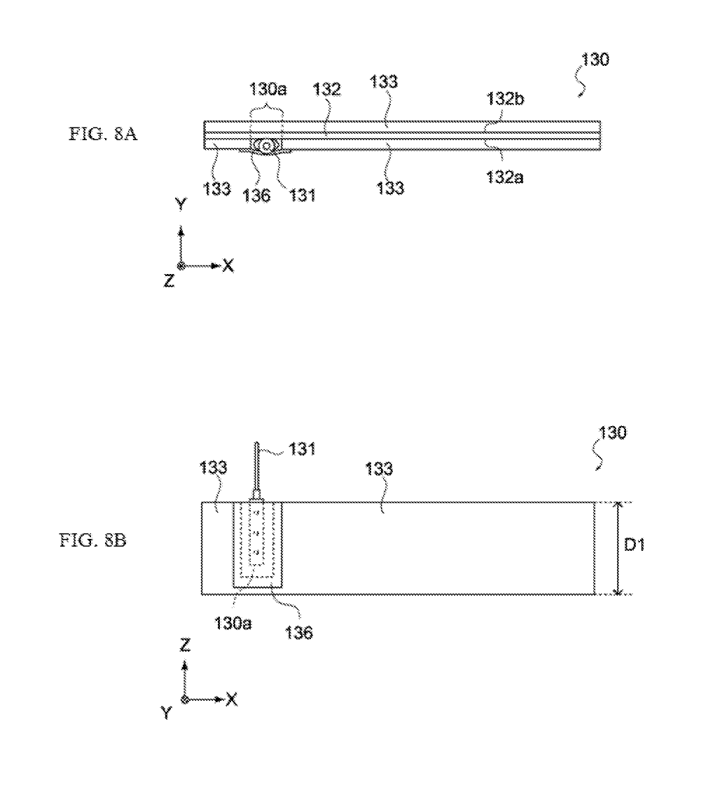

The negative-electrode terminal 131 is covered with a protective tape 136. FIGS. 8A and 8B provide schematic views showing the negative electrode 130 on which the protective tape 136 is provided, where FIG. 8A is a view from the Z direction, while FIG. 8B is a view from the Y direction. The protective tape 136 is a tape made of polypropylene, polyethylene, polyimide, or other insulating material, and preferably resistant to heat and also to the solvent of the electrolytic solution.

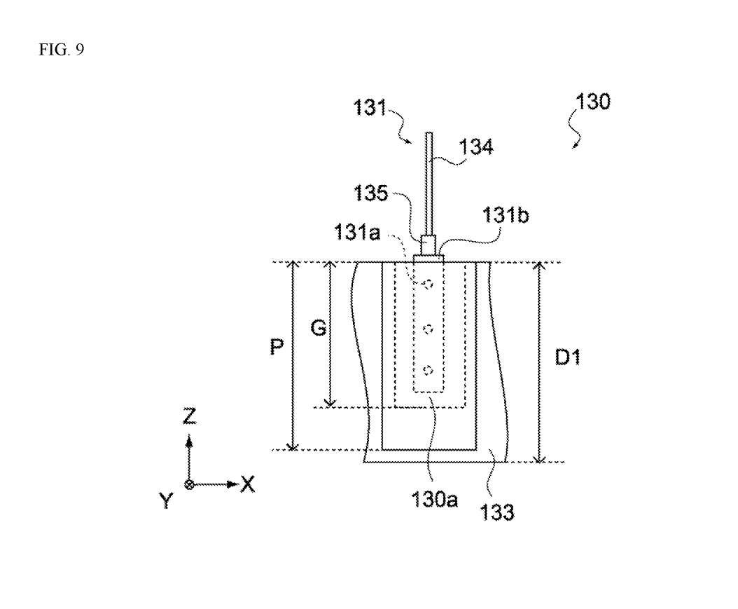

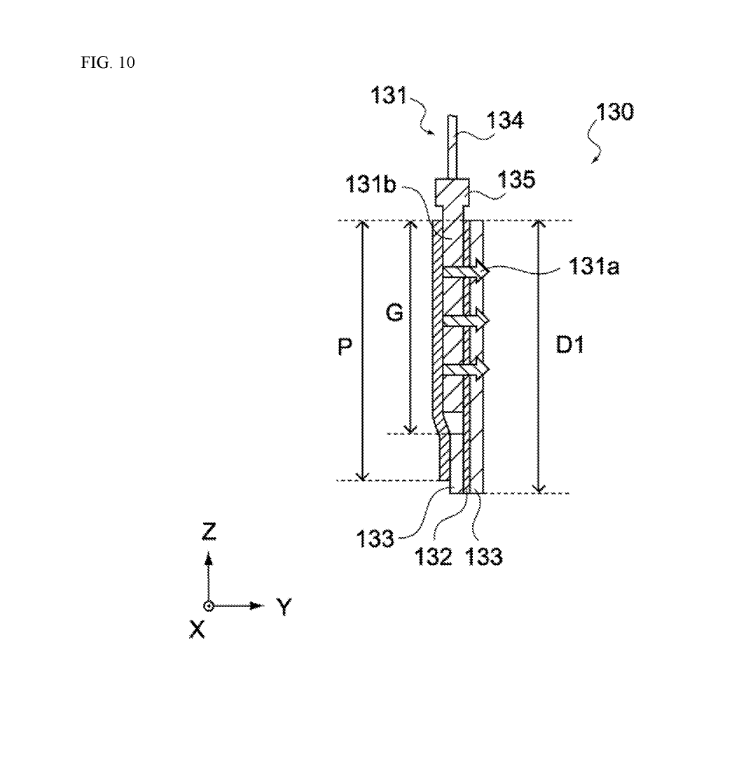

FIG. 9 is a schematic view showing the protective tape 136, while FIG. 10 is a cross sectional view showing the protective tape 136. As shown in these figures, preferably the protective tape 136 is attached to the negative-electrode active material layer 133 around the negative-electrode non-forming region 130a and covers the joining part 131b and the negative-electrode non-forming region 130a. As shown in these figures, the length of the protective tape 136 along the direction (Z direction) parallel with the center axis of winding is defined as length P.

The positive electrode 140, as shown in FIG. 3, has a positive-electrode collector 142 and a positive-electrode active material layer 143. The positive-electrode collector 142 is made of conductive material, and may be a metal foil such as aluminum foil. The positive-electrode collector 142 may be a metal foil whose surface is chemically or mechanically roughened, or a metal foil in which through holes are formed. The thickness of the positive-electrode collector 142 may be 30 μm, for example.

The positive-electrode active material layers 143 are formed on the positive-electrode collector 142. The material for the positive-electrode active material layers 143 may be a mixture of a positive-electrode active material and a binder resin, which may further contain a conductive aid. For the positive-electrode active material, any material capable of adsorbing lithium ions and anions in the electrolytic solution may be used, such as activated carbon or polyacene carbide, for example.

For the binder resin, any synthetic resin that joins the positive-electrode active material may be used, such as carboxy methyl cellulose, styrene butadiene rubber, polyethylene, polypropylene, polyethylene terephthalate, aromatic polyamide, fluororubber, polyvinylidene fluoride, isoprene rubber, butadiene rubber, and ethylene propylene rubber, for example.

The conductive aid is constituted by grains made of conductive material, and it improves the conductivity between positive-electrode active materials. The conductive aid may be acetylene black, graphite, carbon black, or other carbon material, for example. Any of these may be used alone or multiple types may be mixed. It should be noted that the conductive aid may be a material having conductivity, such as metal material and conductive polymer, among others.

The positive-electrode active material layer 143 may be provided directly on the positive-electrode collector 142, or it may be provided on an undercoat layer provided on the positive-electrode collector 142. The thickness of the positive-electrode active material layer 143 may be 100 μm, for example.

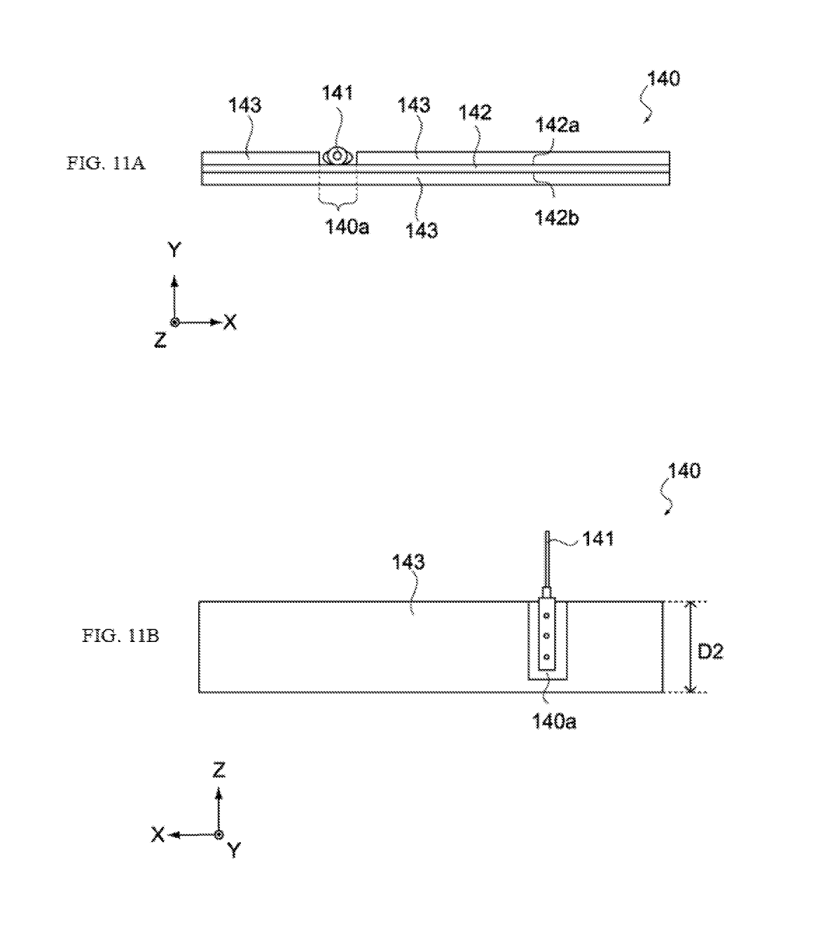

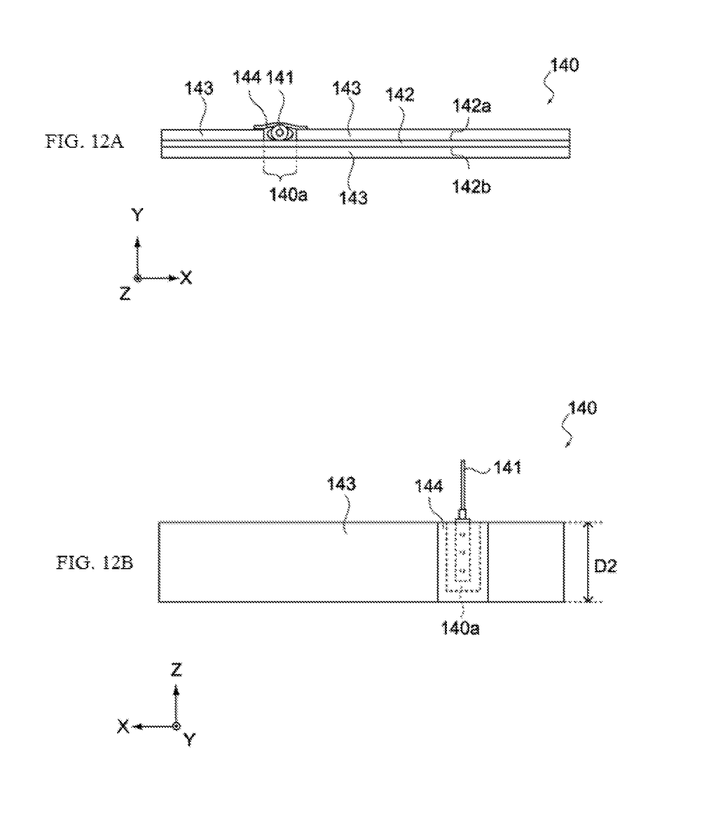

FIGS. 11A and 11B provide schematic views showing the positive electrode 140 before winding, where FIG. 11A is a view from the Z direction, while FIG. 11B is a view from the Y direction. As shown in FIG. 11A, the positive-electrode active material layer 143 is formed on both the first principal face 142a and second principal face 142b of the positive-electrode collector 142 of the positive electrode 140.

As shown in these figures, the positive electrode 140 has a rectangular shape. The width of the short side of the positive electrode 140 is defined as the second width D2. The second width D2 represents the width along the direction (Z direction) parallel with the center axis of winding when the positive electrode 140 is wound with the negative electrode 130 and separators 150.

As shown in FIGS. 11A and 11B, the positive electrode 140 has a positive-electrode non-forming region 140a, and the positive-electrode terminal 141 is joined in the positive-electrode non-forming region 140a. The positive-electrode non-forming region 140a is a region where the positive-electrode active material layer 143 is not provided, but the positive-electrode collector 142 is exposed instead, on the first principal face 142a. In the positive-electrode non-forming region 140a, the width along the direction (Z direction) parallel with the center axis of winding corresponds to the second width D2; in other words, this region is formed from one end to the other end of the positive electrode 140 in the Z direction.

The positive-electrode terminal 141 is joined to the positive-electrode collector 142 exposed in the positive-electrode non-forming region 140a, and is electrically connected to the positive-electrode collector 142. The positive-electrode terminal 141 may be constituted by two line-shaped metal members made of aluminum, etc., which are joined together by means of resistance welding, etc., and it may be joined to the positive-electrode collector 142 using a needle in the form of needle crimping, just like the negative-electrode terminal 131.

The positive-electrode terminal 141 may be covered with a protective tape 144. FIGS. 12A and 12B provide schematic views showing the positive electrode 140 on which the protective tape 144 is provided, where FIG. 12A is a view from the Z direction, while FIG. 12B is a view from the Y direction. The protective tape 144 is a tape made of polypropylene, polyethylene, polyimide, or other insulating material, and preferably resistant to heat and also to the solvent of the electrolytic solution. As shown in these figures, preferably the protective tape 144 is attached to the positive-electrode active material layer 143 around the positive-electrode non-forming region 140a and covers the positive-electrode terminal 141 and the positive-electrode non-forming region 140a.

The separator 150 separates and insulates the negative electrode 130 and positive electrode 140, while letting the ions contained in the electrolytic solution described later pass through it. To be specific, the separator 150 may be made of paper, woven fabric, non-woven fabric, or microporous membrane of synthetic resin, or the like.

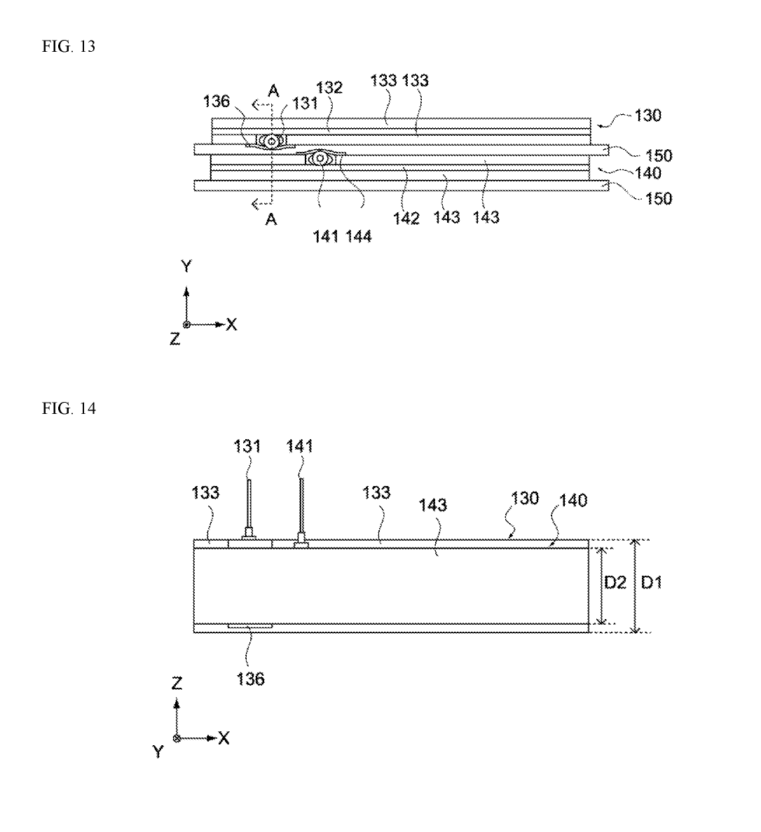

The negative electrode 130 and positive electrode 140 are stacked and wound together with the separator 150 in between. FIG. 13 is a schematic view of a laminate constituted by the negative electrode 130, positive electrode 140, and separators 150, stacked together. As shown in this figure, they are stacked in the order of separator 150, positive electrode 140, separator 150, and negative electrode 130.

FIG. 14 is a schematic view of the negative electrode 130 and positive electrode 140 stacked together, not showing the separators 150. As shown in this figure, the second width D2 is smaller than the first width D1.

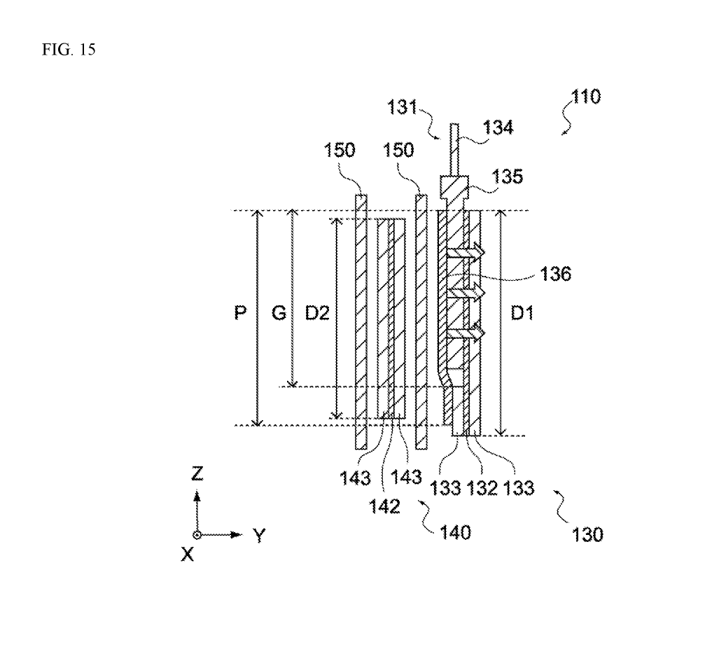

FIG. 15 is a cross sectional view of a laminate constituted by the negative electrode 130, positive electrode 140, and separators 150, stacked together, corresponding to a cross sectional view of FIG. 13 along line A-A. As shown in this figure, the length P of the protective tape 136 is equal to or greater than the second width D2 being the width of the positive electrode 140.

The electric storage element 110 may be produced by winding, around a winding core C, the laminate constituted by the negative electrode 130, positive electrode 140, and separators 150, stacked together as described above.

The container 120 houses the electric storage element 110. The top face and bottom face of the container 120 may be closed by lids (not illustrated). The material of the container 120 is not limited in any way, and may be a metal whose primary component is aluminum, titanium, nickel or iron, or stainless steel, for example.

The electrochemical device 100 is constituted as described above. The electrolytic solution housed in the container 120 together with the electric storage element 110 is a liquid containing lithium ions and anions; for example, it may be a liquid prepared by dissolving an electrolyte, such as LiBF₄ or LiPF₆, in a solvent (propylene carbonate, etc.).

Lithium ions are pre-doped into the negative electrode 130 of the electrochemical device 100. Lithium ion pre-doping is performed by, for example, electrically connecting to the negative electrode 130 a lithium ion source containing metal lithium, and then immersing the electric storage element 110 in the electrolytic solution. Lithium ion pre-doping may also be performed using other methods. Lithium ions released from the lithium ion source are doped into the negative-electrode active material layer 133 via the electrolytic solution.

[Effects of the Electrochemical Device]

As described above, the length P of the protective tape 136 is equal to or greater than the second width D2 being the width of the positive electrode 140. The effects of this are explained using a comparative example.

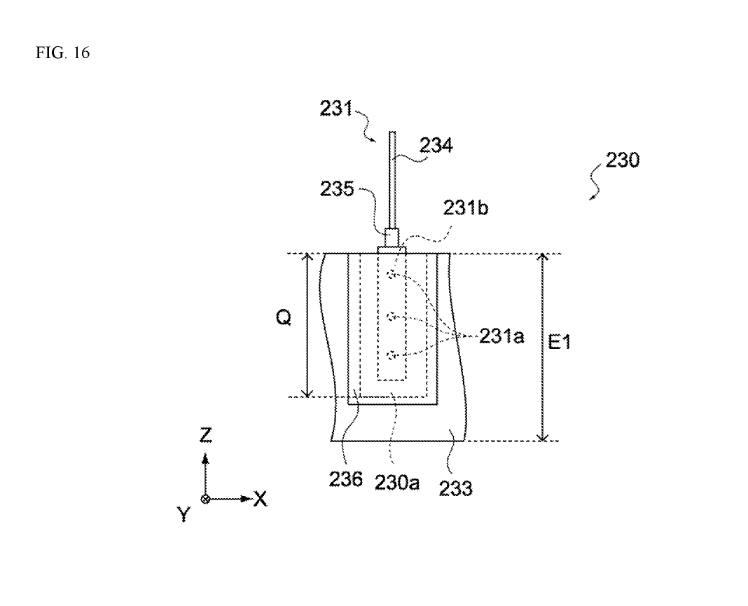

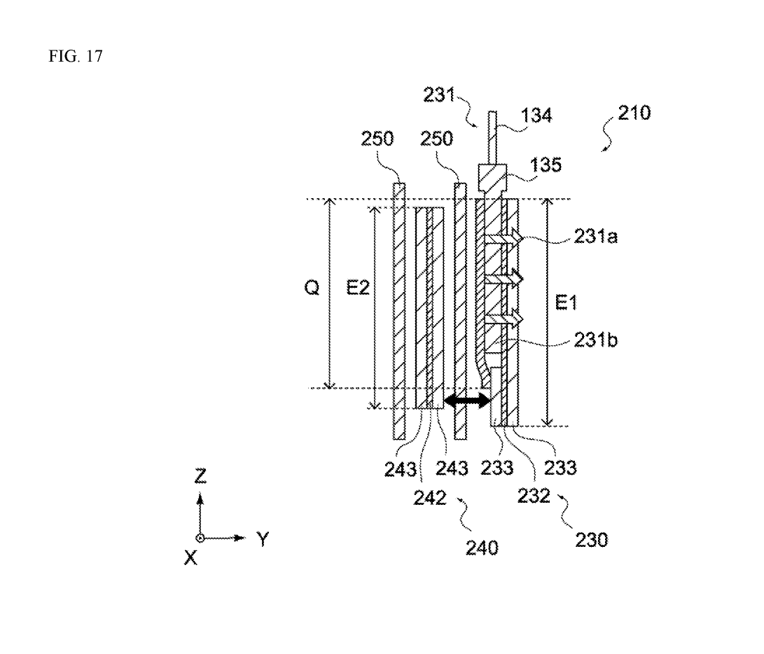

FIG. 16 is a schematic view of the negative electrode of the electric storage element 210 pertaining to the comparative example, while FIG. 17 is a cross sectional view of the electric storage element 210. As shown in FIG. 16, the electric storage element 210 has a negative electrode 230, a positive electrode 240, and separators 250. The negative electrode 230 has a negative-electrode terminal 231, a negative-electrode collector 232, a negative-electrode active material layer 233, and a protective tape 236. The negative-electrode terminal 231 is joined to the negative-electrode collector 232 using a needle 231a. The positive electrode 240 has a positive-electrode terminal (not illustrated), a positive-electrode collector 242, and a positive-electrode active material layer 243.

As shown in FIG. 17, the width E1 of the negative electrode 230 is greater than the width E2 of the positive electrode 240, and the width Q of the protective tape 236 is smaller than the second width E2. In this case, an area where the protective tape 236 is present, and an area where the protective tape 236 is absent, are formed on the negative electrode 230 in the Z direction. As shown by the arrows in the figure, the area where the protective tape 236 is absent becomes a non-uniform area that faces the positive electrode 240 via the separator 250 and reacts with the part of the positive electrode 240 it faces, and also with parts of the positive electrode 240 in the vicinity thereof, to cause charging and discharging to occur. This non-uniformity promotes local deterioration of the electric storage element 210.

With the electric storage element 110 pertaining to the embodiment illustrated in FIG. 15, on the other hand, the length P of the protective tape 136 is equal to or greater than the width D2 of the positive electrode 140, and this prevents the formation of an area where the protective tape 136 is present, and an area where the protective tape 136 is absent, on the negative electrode 130, in the Z direction. As a result, local deterioration of the electric storage element 110 can be suppressed.

[Variation Example]

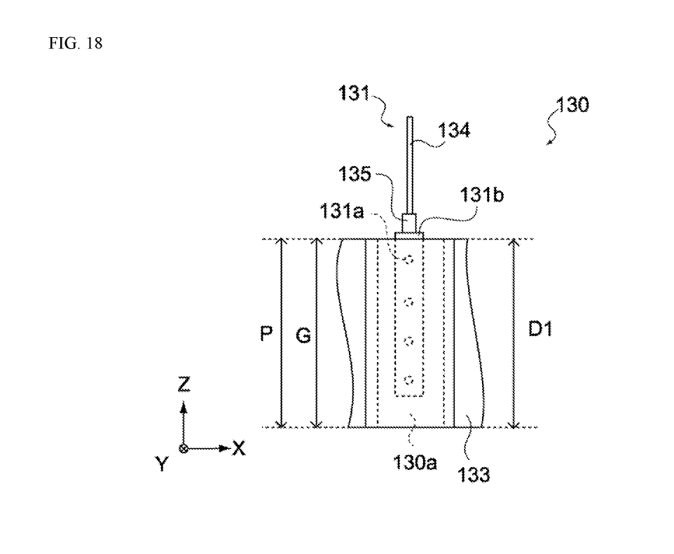

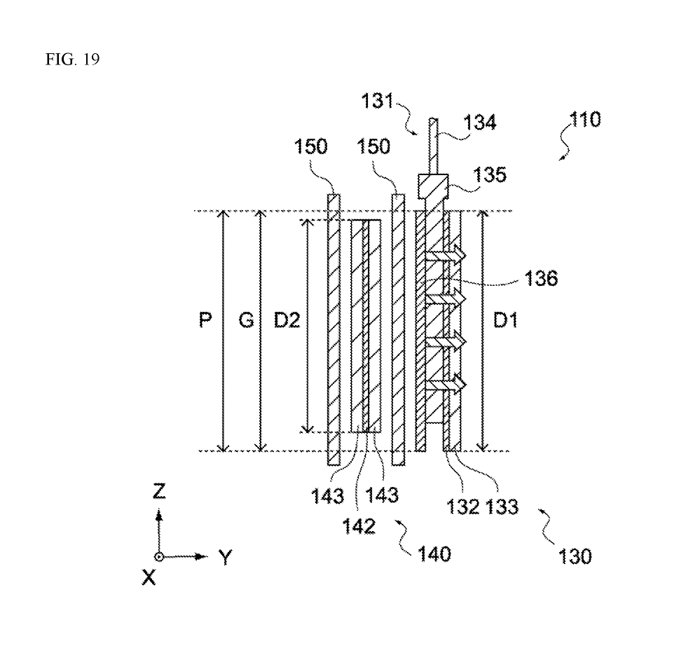

It was described in the aforementioned embodiment that the negative-electrode non-forming region 130a has, along the Z direction, a width G which is smaller than the width D1 of the negative electrode 130; however, the width G may be the same as the width D1. FIGS. 18 and 19 are schematic views showing the negative-electrode non-forming region 130a pertaining to the variation example. As shown in these figures, the length P of the protective tape 136 along the Z direction is the same as the width D1, and it covers the negative-electrode non-forming region 130a and the joining part 131b.

This structure also prevents the formation of an area where the protective tape 136 is present, and an area where the protective tape 136 is absent, on the negative electrode 130, in the Z direction. As a result, local deterioration of the electric storage element 110 can be suppressed.

### EXAMPLES

An electric storage element was produced and its structure was evaluated. To be specific, a positive-electrode paste was produced by mixing and kneading an active material or specifically activated carbon, a conductive aid, and a binder, in water containing thickening agent. This positive-electrode paste was applied on an aluminum foil of 30 μm in thickness that had been etched to add gas permeability, and then dried, to form a positive-electrode active material layer of 100 μm in thickness on one side of the aluminum foil.

Also, a negative-electrode paste was produced by mixing and kneading an active material or specifically non-graphitizable carbon, a conductive aid, and a binder, in water containing thickening agent. This negative-electrode paste was applied on a copper foil of 15 μm in thickness that had been etched to make 100-μm diameter holes covering 30% of the entire area, and then dried, to form a negative-electrode active material layer of 50 μm in thickness on one side of the copper foil.

The positive electrode was cut to 24 mm in width (Z direction) and 170 mm in length (X direction), after which the positive-electrode active material layer was partially peeled, to form a positive-electrode non-forming region. The positive-electrode terminal was joined to the positive-electrode non-forming region by means of needle crimping. The negative electrode was cut to 27 mm in width (Z direction) and 240 mm in length (X direction), after which the negative-electrode active material layer was partially peeled, to form a negative-electrode non-forming region. The negative-electrode terminal was joined to the negative-electrode non-forming region by means of needle crimping.

A protective tape resistant to heat and solvent was attached to the joining part and negative-electrode non-forming region of the negative-electrode terminal. In the comparative example, the length (Z direction) of the protective tape was made equivalent to the length of the negative-electrode non-forming region (length smaller than the width of the positive electrode), and in the example, the length of the protective tape was made equal to or greater than the width of the positive electrode.

For the separators, a cellulose separator of 0.45 g/cm³ in density and 35 μm in thickness was cut to 30 mm in width and the cut pieces were used. The positive electrode and negative electrode were held for 12 hours at 180° C. under a reduced pressure of 1 kPa or less, until dry. The separators were held for 12 hours at 160° C. under a reduced pressure of 1 kPa or less, until dry.

They were stacked in the order of positive electrode, separator, negative electrode, and separator, and then wound together by maintaining the relationship of the positive-electrode active material layer and negative-electrode active material layer facing each other with the separator in between, to assemble an electric storage element whose outermost periphery was constituted by the separator. A lithium foil of 0.1 mm in thickness, 25 mm in width and 25 mm in length was attached to the copper foil surface of the negative electrode on the outermost periphery, and the separators were secured together by tape. Rubber was fitted to seal the positive-electrode terminal and negative-electrode terminal.

An electrolytic solution was produced by dissolving 1.0 mol/L of LiPF₆ in propylene carbonate. The electric storage element was inserted in an aluminum case of 12.5 mm in diameter, after which the case was crimped and sealed. Twenty electrochemical devices pertaining to the example, and twenty electrochemical devices pertaining to the comparative example, were produced as described above.

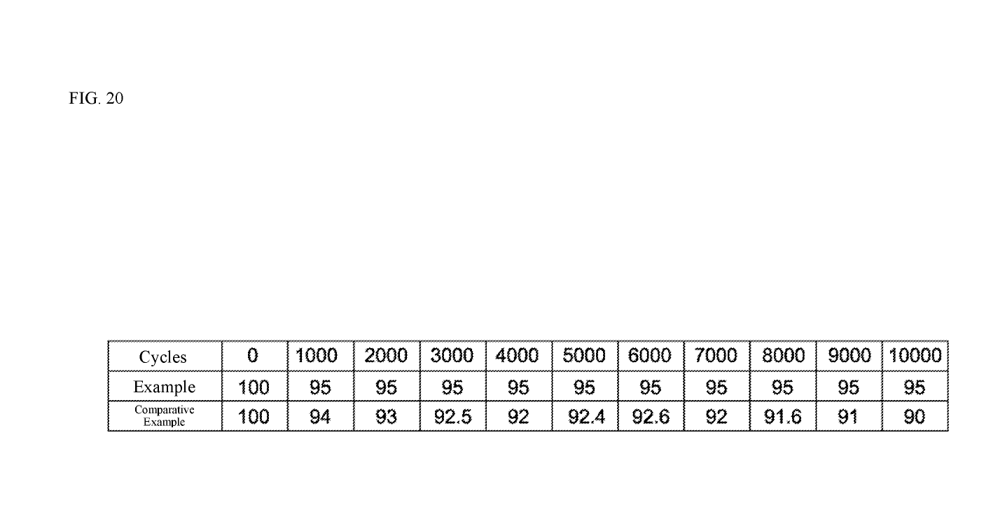

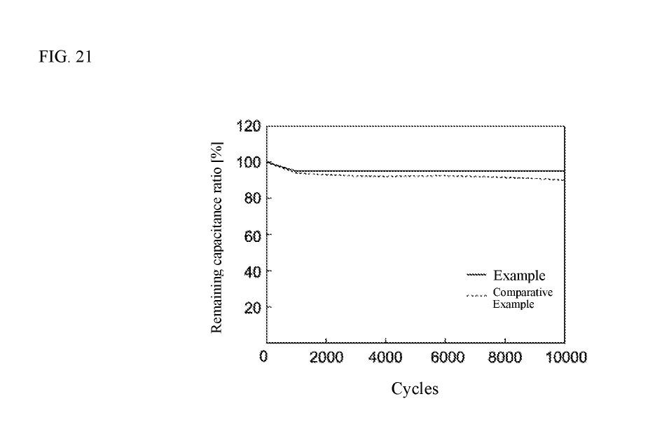

Each electrochemical device was put through charging and discharging cycles and then the remaining capacitance ratio was measured. FIG. 20 is a table showing the measured results, while FIG. 21 is a graph showing the measured results. As shown in these figures, the electrochemical devices pertaining to the example experienced smaller drops in remaining capacitance ratios compared to the electrochemical devices pertaining to the comparative example over cycles, suggesting that capacitance deterioration was suppressed under the example.

In the present disclosure where conditions and/or structures are not specified, a skilled artisan in the art can readily provide such conditions and/or structures, in view of the present disclosure, as a matter of routine experimentation. Also, in the present disclosure including the examples described above, any ranges applied in some embodiments may include or exclude the lower and/or upper endpoints, and any values of variables indicated may refer to precise values or approximate values and include equivalents, and may refer to average, median, representative, majority, etc. in some embodiments. Further, in this disclosure, “a” may refer to a species or a genus including multiple species, and “the invention” or “the present invention” may refer to at least one of the embodiments or aspects explicitly, necessarily, or inherently disclosed herein. The terms “constituted by” and “having” refer independently to “typically or broadly comprising”, “comprising”, “consisting essentially of”, or “consisting of” in some embodiments. In this disclosure, any defined meanings do not necessarily exclude ordinary and customary meanings in some embodiments.

The present application claims priority to Japanese Patent Application No. 2016-069137, filed Mar. 30, 2016, the disclosure of which is incorporated herein by reference in its entirety including any and all particular combinations of the features disclosed therein.

It will be understood by those of skill in the art that numerous and various modifications can be made without departing from the spirit of the present invention. Therefore, it should be clearly understood that the forms of the present invention are illustrative only and are not intended to limit the scope of the present invention.

We/I claim:

1. A electrochemical device, comprising:
a negative electrode having a negative-electrode collector being a metal foil, and a negative-electrode active material layer formed on a principal face of the negative-electrode collector;
a positive electrode having a positive-electrode collector being a metal foil, and a positive-electrode active material layer formed on a principal face of the positive-electrode collector;
a negative-electrode terminal made of metal, and having a joining part which is a part joined to the principal face of the negative-electrode collector;
a protective tape made of insulating material and attached to the negative electrode to cover the joining part;
separators insulating the positive electrode and negative electrode; and
electrolytic solution immersing the positive electrode, negative electrode, and separators;
where the positive electrode, negative electrode, and separators are stacked and wound together in such a way that the separators separate the positive electrode and negative electrode;
wherein,
the negative electrode has a first width along a direction parallel with the axis of winding;
the positive electrode has a second width, which is smaller than the first width, along the direction parallel with the axis of winding; and
a length of the protective tape along the direction parallel with the axis of winding is equal to or greater than the second width.

2. An electrochemical device according to claim 1, wherein lithium ions are pre-doped into the negative-electrode active material layer.

3. An electrochemical device according to claim 1, wherein the negative electrode has a negative-electrode non-forming region where the negative-electrode active material layer is not formed on the principal face;
the negative-electrode terminal is joined to the negative-electrode collector in the negative-electrode non-forming region; and
the protective tape is attached to the negative-electrode active material layer around the negative-electrode non-forming region and covers the negative-electrode non-forming region and the joining part.

4. An electrochemical device according to claim 1, wherein the negative electrode has a negative-electrode non-forming region where the negative-electrode active material layer is not formed on the principal face;
the negative-electrode terminal is joined to the negative-electrode collector in the negative-electrode non-forming region; and
the protective tape is attached to the negative-electrode active material layer around the negative-electrode non-forming region and covers the negative-electrode non-forming region and the joining part.

5. An electrochemical device according to claim 1, further comprising:
a positive-electrode terminal made of metal, and having a joining part which is a part joined to the principal face of the positive-electrode collector;

6. An electrochemical device according to claim 5, further comprising a protective tape made of insulating material and attached to the positive electrode to cover the joining part.

7. An electrochemical device according to claim 6, wherein the positive electrode has a positive-electrode non-forming region where the positive-electrode active material layer is not formed on the principal face; and the protective tape is attached to the positive-electrode active material layer around the positive-electrode non-forming region and covers the positive-electrode non-forming region and the joining part.
